(19) United States
(12) Patent Application Publication
(10) Pub. No.: US 2006/0286228 A1
(43) Pub. Date: Dec. 21, 2006

(54) Elimination of pathogens on cooked and other ready-to-eat products and on processing surfaces using electrolyzed water

(76) Inventors: David Howard, Tulsa, OK (US); Brian Denomme, Northville, MI (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/153,774

(22) Filed: Jun. 15, 2005

(51) Int. Cl. A23B 4/20

(52) U.S. Cl. 426/332

(57) ABSTRACT

A method of preventing or reducing food product contamination comprising contacting either a surface within a processing facility, a food processing equipment surface, an already-cooked food or other ready-to-eat product surface, or a combination thereof with an electrolyzed aqueous solution which is lethal for at least one pathogen and is not harmful for human consumption.

### FIELD OF THE INVENTION

The present invention relates to methods for eliminating or significantly reducing Listeria, salmonella, and other pathogens on cooked product surfaces (with or without casings), on fruits, on vegetables, on nuts, and on all manner of processing equipment and processing environment surfaces.

### BACKGROUND OF THE INVENTION

The U.S. Department of Agriculture (USDA) and the U.S. Food and Drug Administration (FDA) have maintained long-standing zero tolerance policies and requirements for Listeria monocytogenes and salmonella for ready-to-eat (RTE) foods. The USDA Food Safety Inspection Service (FSIS) has also implemented the Pathogen Reduction Act/Hazard Analysis and Critical Control Point (HACCP) plan to reduce meat-related and poultry-related outbreaks due to Listeria monocytogenes, E-coli, Campylobacter, and salmonella. Although RTE meat products are fully cooked, they are often re-exposed to bacteria in the processing environment. Such bacteria may be present, for example, on the surfaces of slicing machines, packaging machines, or other processing equipment or elsewhere in the processing facility. Because RTE products are most often consumed without further cooking, the presence of pathogens on such products due to re-exposure after cooking presents a serious food safety threat.

As of 1999, the largest number of recalls in the food industry were due to Listeria monocytogenes. Listeria monocytogenes has several characteristics that make it a formidable pathogen and contaminant in food processing environments. These include: high heat and salt tolerance; the ability to grow at refrigeration temperatures; and the ability to form biofilms on all kinds of surfaces in the processing environment.

Ensuring that RTE and other already-cooked food products are not contaminated during processing in slicing or packaging machines has proven to be particularly problematic. In slicing machines, for example, the intricate design required for the blade housing is typically very difficult to clean. In addition, the extended running time of most slicing operations (i.e., typically from 8 to 16 hours between cleaning shifts) provides ample opportunity for pathogens to grow. As understood by those in the art, the need to prevent any recontamination of a product during the slicing process is particularly important in view of the current lack of practical post-lethality treatment processes in the industry for sliced cooked meats.

It is also a USDA requirement for cooked meat products having outer casings that the casing be washed prior to bringing the product into a clean environment such as a slicing room. The outer casing of the product can harbor Listeria, salmonella, E-coli and/or other pathogens which can contaminate the clean environment and equipment and can also contaminate the product itself during slicing and/or casing removal. Current methods used for cleaning cooked product casings have significant shortcomings. The use of chemical agents which may come into contact with the product are harmful to product quality and are typically not recommended for human consumption.

Although the use of ozone as an alternative for killing microorganisms on cooked food products has been generally recognized as safe, ozone is inherently unstable and unreliable for pathogen lethality. In addition, when used in connection with some cooked products, particularly those not contained in casings, ozone can negatively affect the sensory attributes of the product. In addition, neither the chemical nor the ozone treatments used heretofore have not generally been effective for achieving significantly more than a 0.5 log reduction in live pathogens on organic material.

In addition to slicing and packaging machines, other equipment such as product shelves and trucks used for holding, storing, and transporting cooked products pose significant contamination problems. Examples of other areas in food plants known to be particularly susceptible for the growth of Listeria monocytogenes and other pathogens include floors, floor drains, walls, and curbings. The presence of pathogens in these or other areas throughout the food plant pose contamination problems for both cooked as well as uncooked products. Electrical control devices and equipment, such as control panels with touch screens or switches, also provide potential cross-contamination points due to repeated operator contact but generally cannot be decontaminated by submerging, drenching, or similar procedures.

U.S. Pat. No. 6,610,249 B1 discloses the use of an electro-chemically activated, anion-containing aqueous solution for disinfecting raw animal products and carcasses and raw sausage casings. The entire disclosure of U.S. Pat. No. 6,610,249 B1 is incorporated herein by reference. The electro-chemically activated, anion-containing aqueous solution is formed by electrolyzing an aqueous salt solution. Examples of preferred salt materials include non-iodated sodium chloride or potassium chloride. The electrolyzed anion-containing solution preferably has a pH in the range of from about 2 to about 8 and a redox potential of between about ⁺500 mV and about ⁺1170 mV and will typically include one or more of the following species: ClO, ClO⁻, HClO, OH⁻, HO₂—, H₂O₂, O₃, S₂O₈²⁻, and Cl₂O₆²⁻. The electrolyzed aqueous solution is disclosed as being effective against viral organisms and spore and cyst-forming bacteria and is preferably applied at low temperature. The disclosed application procedures include soaking, rinsing, or dipping the raw product, as well as atomizing or fogging the electrolyzed anion-containing aqueous solution for treating carcasses suspended in a chiller or for addition to air duct systems to destroy air-borne microorganisms. The patent also discloses the formation of an electro-chemically activated, cation-containing aqueous solution.

### SUMMARY OF THE INVENTION

In order to ensure that the objectives of the zero tolerance policies and requirements for RTE and other already cooked food products can be achieved with certainty, a need exists for a method of obtaining essentially zero tolerance for Listeria, salmonella, and other pathogens throughout substantially the entire interior of the food plant and on substantially all of the equipment and systems surfaces therein. The method will preferably be operable for killing and eliminating such pathogens from the facility on a continuous basis and will also preferably be effective for continuously treating slicing machines and other processing equipment and systems even during use. A need further exists for a method of reducing or preferably eliminating pathogens from cooked products and cooked product casings wherein essentially no heat is added to the product and therefore no additional cooling is required. The method will preferably achieve at least a 2 log reduction in Listeria on the surface or product in question. The method will more preferably achieve at least a 3, 4, or 5 log reduction in Listeria on the surface or product and will most preferably achieve at least a 6 log reduction in Listeria. Moreover, the inventive method will preferably not utilize any composition or material which is in any way harmful for human consumption or which has any detrimental effect on the quality or sensory attributes of the product.

The present invention satisfies these needs and alleviates the problems discussed above. In one aspect, there is provided a method of preventing contamination of food products in a food processing facility comprising the step of contacting a surface within the processing facility with an electrolyzed aqueous solution which is lethal for at least one pathogen and is not harmful for human consumption, wherein the surface is a structural surface or an equipment surface.

In another aspect, there is provided a method of pathogen reduction for an already-cooked food product comprising the step of directly contacting a surface of the already-cooked food product with an electrolyzed aqueous solution which is lethal for at least one pathogen and is not harmful for human consumption, wherein the surface has no casing, packaging, or other covering thereon in the step of contacting.

In another aspect, there is provided a method of protecting an already-cooked food product contained in a covering from contamination by Listeria, wherein the covering is a casing or a cooking bag or other package. The method comprises the step of contacting the covering with an electrolyzed aqueous solution which is lethal for Listeria and is not harmful for human consumption.

In another aspect, there is provided a method of packaging already cooked products having casings thereon. The method comprises the steps of (a) contacting the casings with an electrolyzed aqueous solution which is lethal for Listeria and is not harmful for human consumption and then (b) placing the already-cooked food products having the casings thereon in packages, wherein the casings are still wet with the electrolyzed aqueous solution during the step of placing.

In yet another aspect, there is provided a method of pathogen reduction for a fruit or vegetable comprising the step of contacting the fruit or vegetable with an electrolyzed aqueous solution which is lethal for at least one pathogen and is not harmful for human consumption.

Further aspects, features, and advantages of the present invention will be apparent to those in the art upon reading the following detailed description of the preferred embodiments.

### DETAILED DESCRIPTION OF THE PREFERRED EMBODIMENTS

The present invention provides a method of preventing or reducing pathogen contamination on the surfaces of food products which are already cooked or which can be or are likely to be eaten raw or without further cooking. Examples of such products include but are not limited to: RTE or other already-cooked meat, poultry, or fish products; lettuce or other raw or cooked vegetables; raw or cooked fruits; almonds, pecans and other nuts with or without shells; or combinations thereof. Examples of RTE and other already-cooked meat, poultry, and fish products include but are not limited to slicing logs, sliced products, whole muscle products, bone-in products, boneless products, meatloaves, frankfurters, hot dogs, and other wiener products, salami, sausages, etc.

In one aspect of the inventive method, the surface of the food product is contacted with an electrolyzed aqueous solution. In another aspect of the inventive method, contamination of food products of the type already described, as well as raw meat, poultry, or fish products or other types of products which are not ready-to-eat, is prevented by contacting the structural and/or equipment surfaces within food processing facilities with an electrolyzed aqueous solution.

The electrolyzed aqueous solution used in accordance with the present invention can generally be any electrolyzed aqueous solution which is lethal for one or more pathogens and is not harmful for human consumption. As used herein and in the claims, the term “lethal” means that the electrolyzed aqueous solution is capable of killing or otherwise damaging or destroying a pathogen such that it is no longer capable of causing illness. The electrolyzed aqueous solution employed in the present invention will preferably be lethal for at least Listeria monocytogenes and will also preferably be lethal for salmonella. The electrolyzed aqueous solution will most preferably be lethal for at least Listeria, salmonella, and E-coli.

The electrolyzed aqueous solution employed in the present invention will preferably be an electro-chemically activated, ion-containing aqueous solution and will most preferably be an electro-chemically activated predominantly anion-containing solution. An example of an electro-chemically activated, anion-containing solution preferred for use in the inventive method is disclosed and described in U.S. Pat. No. 6,610,249 B1.

The electrolyzed aqueous solution can be applied in accordance with the inventive method using any technique which is convenient for the structural surface, equipment surface, product surface, or other surface in question and which is effective for contacting or covering the surface sufficiently to achieve the desired degree of lethality. Examples of possible application techniques include but are not limited to drenching, dipping, fogging, misting, spraying, deluging, or a combination thereof. The electrolyzed aqueous solution can even be applied in accordance with the present invention as a spray or spritz to fruits and vegetables in a supermarket display.

By way of example, to prevent contamination of food products in a processing plant, the inventive method can be used to treat generally any or all structural and/or equipment surfaces within a product clean room (e.g., a slicing and/or packaging room) or within the entire plant by (a) fogging or misting the entire room or plant with the electrolyzed aqueous solution and/or (b) directly spraying, deluging, or otherwise contacting particular surfaces which are more difficult to reach and/or more critical for preventing product contamination. Examples of surfaces within food processing plants which are particularly susceptible to pathogen contamination and growth include floors, walls, curbings, floor drains, product trucks used for holding and transporting multiple product pieces from one operation to the next, slicing machines, and packaging machines.

The electrolyzed aqueous solution can also be fogged, misted, sprayed, or otherwise applied to the interior surfaces of cooking apparatuses, cooling apparatuses, freezing apparatuses, or any other type of processing machine or equipment. In the case of cookers, chillers, and other processing devices and apparatuses which are equipped with clean-in-place systems, the electrolyzed aqueous solution can be used to replace the detergent or other cleaning solution normally used in the system and will also eliminate the need for conducting a rinse step in the cleaning process. Further, the electrolyzed aqueous solution can be fogged or misted onto control panels or other operator interfaces without damaging the electrical equipment.

In another aspect of the inventive method, the electrolyzed aqueous solution can be applied to the food contacting surfaces and/or other surfaces of food processing devices and systems while the devices and systems are in operation. Examples of systems wherein such application is particularly desirable include but are not limited to packaging machines and the blade holders and/or other components of product slicing machines. In such cases, the electrolyzed aqueous solution may also incidentally or intentionally contact the food product itself and it is in no way harmful or detrimental. The application of the electrolyzed aqueous solution to the equipment during operation can be performed as needed either periodically, intermittently, or continuously.

The already cooked products treated in accordance with the present invention can be products which have been cooked or otherwise prepared in or without casings, cooking bags, or other product coverings. The electrolyzed aqueous solution can be applied either (a) directly to the actual (i.e., uncovered) surface of the product itself, (b) to the exterior of a casing, cooking bag, or other covering in which the product is contained, or (c) both. As one example, an already-cooked food product having no casing, bag, or other covering thereon can be contacted with an electrolyzed aqueous solution and then optionally placed in its final packaging while still wet so that the electrolyzed aqueous solution continues to protect the product and prevent contamination during and after the packaging step. As another example, the direct contacting of an already-cooked product having no casing or other covering thereon can be combined with a subsequent surface pasteurizing step such as, for example, conducting the product through an infrared surface pasteurizer or pasteurizing the product surface using heated water. The additional surface pasteurizing step can be conducted before or after the product is packaged or both.

As another example wherein the already-cooked food product is a wiener or other product contained within a casing, the casing can be contacted with the electrolyzed aqueous solution and the cased product can then optionally be packaged while still wet so that the electrolyzed aqueous solution will continue to protect and prevent contamination of the cased product during and after the packaging operation.

As yet another example involving an already-cooked food product which is contained in a casing, a cooking bag, or other covering, the covering can be contacted with the electrolyzed aqueous solution before either (a) slicing the already-cooked food product while it is still contained in the covering, (b) removing the covering, or (c) removing the covering and then slicing the product.

When contacting any structural, equipment, or product surface in accordance with the present invention, the electrolyzed aqueous solution will preferably be unheated and will also preferably be applied in a manner effective for achieving at least a 3 log reduction in Listeria monocytogenes on the surface. In most cases, the electrolyzed aqueous solution will preferably be in contact with the surface for at least one minute and more preferably at least two minutes. The concentration of the electrolyzed aqueous solution can be adjusted as described in U.S. Pat. No. 6,610,249 B1 to obtain the necessary results within the particular contacting time necessary or desired. The electrolyzed aqueous solution will more preferably be applied in a manner effective for achieving at least a 4 log or at least a 5 log reduction in Listeria monocytogenes and will most preferably be applied in a manner effective for achieving at least a 6 log reduction in Listeria monocytogenes on the surface.

### EXAMPLE 1

Listeria monocytogenes, salmonella enteritidis, and E-coli were placed in separate samples of an electro-chemically activated, anion-containing aqueous solution. These same pathogens were also placed in separate samples of 0.1% buffered peptone water and in separate containers of non-electrolyzed water. The non-electrolyzed water was identical to the aqueous solution used for making the electro-chemically activated anion-containing aqueous solution except that the non-electrolyzed solution was not subjected to an electrical current. In each case, samples were removed and plated on Tryptic soy agar at 2, 4, 6 and 8 minutes.

For the peptone and non-electrolyzed water solutions, the concentrations of Listeria monocytogenes, salmonella enteritidis, and E-coli were essentially unchanged even after eight minutes. However, in the electro-chemically activated anion-containing aqueous solutions, 7⁺ log reductions in Listeria monocytogenes, salmonella enteritidis, and E-coli were achieved within the first two minutes.

### EXAMPLE 2

Strongly attaching biofilm forming strains of Listeria monocytogenes were treated with an electro-chemically activated anion-containing aqueous solution and with an otherwise identical non-electrolyzed aqueous solution. Protease release was performed after 15 second treatments, 30 second treatments, 60 second treatments, and 120 second treatments with the two solution in order to release the pathogen cells for quantitative enumeration by plate count. Although essentially no change occurred with the non-electrolyzed solution treatment, a 4.5⁺ log reduction was achieved within just 15 seconds of treatment with the electro-chemically activated anion-containing aqueous solution.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A method of preventing contamination of food products in a food processing facility comprising the step of contacting a surface within said processing facility with an electrolyzed aqueous solution which is lethal for at least one pathogen and is not harmful for human consumption, wherein said surface is a structural surface or an equipment surface.

2. The method of claim 1 wherein said electrolyzed aqueous solution is an electro-chemically activated, anion-containing aqueous solution.

3. The method of claim 1 wherein said surface is a floor surface, a wall surface, or a curbing surface.

4. The method of claim 1 wherein said surface is a surface of a floor drain.

5. The method of claim 1 wherein said surface is a surface of a product truck.

6. The method of claim 1 wherein said surface is a surface of a slicing apparatus.

7. The method of claim 1 wherein said surface is a surface of a packaging machine.

8. The method of claim 1 wherein said surface is an internal surface of a cooking apparatus.

9. The method of claim 1 wherein said surface is an internal surface of a cooling or freezing apparatus.

10. The method of claim 1 wherein said surface is an electronic control panel surface.

11. The method of claim 1 wherein said surface is a surface of a bag removal apparatus.

12. The method of claim 1 wherein said pathogen is Listeria Monocytogenes.

13. The method of claim 12 wherein said surface is contacted with said electrolyzed aqueous solution is a manner effective for achieving at least a 3 log reduction in said Listeria Monocytogenes.

14. The method of claim 12 wherein said surface is contacted with said electrolyzed aqueous solution in a manner effective for achieving at least a 4 log reduction in said Listeria Monocytogenes.

15. The method of claim 12 wherein said surface is contacted with said electrolyzed aqueous solution in a manner effective for achieving at least a 6 log reduction in said Listeria Monocytogenes.

16. The method of claim 12 wherein said electrolyzed aqueous solution is also lethal for salmonella.

17. The method of claim 1 wherein said surface is a surface of an apparatus for continuously processing said food product and said surface is contacted with said electrolyzed aqueous solution while said apparatus is in operation.

18. The method of claim 17 wherein said surface is continuously contacted with said electrolyzed aqueous solution while said apparatus is in operation.

19. The method of claim 17 wherein said surface is intermittently contacted with said electrolyzed aqueous solution while said apparatus is in operation.

20. The method of claim 17 wherein said apparatus is a slicing apparatus or a packaging apparatus.

21. The method of claim 20 wherein said surface is continuously contacted with said electrolyzed aqueous solution while said apparatus is in operation.

22. A method of pathogen reduction for an already cooked food product comprising the step of directly contacting a surface of said already cooked food product with an electrolyzed aqueous solution which is lethal for at least one pathogen and is not harmful for human consumption, wherein said surface has no casing, packaging, or other covering thereon in said step of contacting.

23. The method of claim 22 wherein said electrolyzed aqueous solution is an electro-chemically activated, anion-containing aqueous solution.

24. The method of claim 22 wherein said already cooked food product is a poultry, meat, or fish product.

25. The method of claim 22 wherein said pathogen is Listeria Monocytogenes.

26. The method of claim 25 wherein said electrolyzed aqueous solution is also lethal for salmonella.

27. The method of claim 25 wherein said surface is contacted with said electrolyzed aqueous solution in a manner effective for achieving at least a 3 log reduction in said Listeria Monocytogenes.

28. The method of claim 25 wherein said surface is contacted with said electrolyzed aqueous solution in a manner effective for achieving at least a 4 log reduction in said Listeria Monocytogenes.

29. The method of claim 25 wherein said surface is contacted with said electrolyzed aqueous solution in a manner effective for achieving at least a 6 log reduction in said Listeria Monocytogenes.

30. The method of claim 22 further comprising the step, following said step of contacting, of packaging said already cooked food product, wherein said surface is still wet with said electrolyzed aqueous solution during said step of packaging.

31. The method of claim 22 further comprising the step, following said step of contacting, of pasteurizing said surface.

32. The method of claim 31 wherein said surface is pasteurized by exposure to infrared energy.

33. The method of claim 31 wherein said surface is pasteurized using heated water.

34. The method of claim 31 further comprising the step, after said step of contacting and prior to said step of pasteurizing, of packaging said already cooked food product.

35. A method of protecting an already cooked food product contained in a covering from contamination by Listeria, said covering being a casing or a cooking bag or other package and said method comprising the step of contacting said covering with an electrolyzed aqueous solution which is lethal for said Listeria and is not harmful for human consumption.

36. The method of claim 35 further comprising the step, following said step of contacting, of slicing said already cooked food product, said already cooked food product being contained in said covering during said step of slicing.

37. The method of claim 35 further comprising the steps, following said step of contacting of:
removing said covering from said already cooked food product and then slicing said already cooked food product.

38. A method of packaging already cooked food products having casings thereon comprising the steps of:
(a) contacting said casings with an electrolyzed aqueous solution which is lethal for Listeria and is not harmful for human consumption and then
(b) placing said already cooked food products having said casings thereon in packages, wherein said casings are still wet with said electrolyzed aqueous solution during said step of placing.

39. The method of claim 38 wherein said already cooked food products are wieners.

40. A method of pathogen reduction for a fruit, vegetable, or nut comprising the step of contacting said fruit, vegetable, or nut with an electrolyzed aqueous solution which is lethal for at least one pathogen and is not harmful for human consumption.

41. The method of claim 40 wherein said pathogen is Listeria Monocytogenes.

42. The method of claim 40 wherein said pathogen is salmonella.

43. The method of claim 40 wherein said fruit, vegetable, or nut is lettuce.
